(19) United States
(12) Patent Application Publication
(10) Pub. No.: US 2007/0149123 A1
(43) Pub. Date: Jun. 28, 2007

(54) Multiple radio usage in a wireless communications device

(76) Inventor: Arto Palin, Viiala (FI)

Correspondence Address: MORGAN & FINNEGAN, LLP, 3 World Financial Center, New York, NY, 10281-2101, US

(21) Appl. No.: 11/318,581

(22) Filed: Dec. 28, 2005

(51) Int. Cl. H04B 7/00

(52) U.S. Cl. 455/41.2

(57) ABSTRACT

An apparatus has multiple radio modules, a connection identifier resolution module, and a host controller. Each of the radio modules communicates over a wireless connection and assigns an identifier (e.g., a Bluetooth connection handle) to its corresponding wireless connection. The connection identifier resolution module identifies two or more conflicting connection identifiers assigned by the multiple radio modules. In addition, the connection identifier resolution module assigns one or more alternate connection identifiers. Each of the one or more alternate connection identifiers corresponds to a respective one of the two or more conflicting connection identifiers. The host controller employs the one or more alternate connection identifiers when exchanging information with the plurality of radio modules.

### FIELD OF THE INVENTION

The present invention relates to wireless communications. More particularly, the present invention relates to techniques employed by devices having multiple radios.

### BACKGROUND OF THE INVENTION

Wireless communications techniques are becoming extremely popular for providing local connectivity solutions. For instance, devices are emerging that can provide several types of wireless network connections.

Bluetooth defines a short-range wireless technology that was originally intended as a cable replacement. Bluetooth can be used to create ad hoc networks of multiple devices (also referred to as terminal devices). One of these devices is referred to as a master device, while the other devices are referred to as slave devices. The slave devices can communicate with the master device and with each other via the master device. The devices typically operate in the 2.4 GHz radio band reserved for general use by Industrial, Scientific, and Medical (ISM) applications. Bluetooth devices are designed to find other Bluetooth devices within their communications range and to discover what services they offer.

Ultra wideband (UWB) is an emerging wireless technology that offers higher data rates. Current FCC regulations permit UWB transmissions for communications purposes in the frequency band between 3.1 and 10.6 GHz. However, for such transmissions, the spectral density has to be under −41.3 dBm/MHz and the utilized bandwidth has to be higher than 500 MHz.

There are many UWB transmission techniques that can fulfill these requirements. A common and practical UWB technique is called impulse radio (IR). In IR, data is transmitted by employing short baseband pulses that are separated in time by gaps. Thus, IR does not use a carrier signal. These gaps make IR much more immune to multipath propagation problems than conventional continuous wave radios. RF gating is a particular type of IR in which the impulse is a gated RF pulse. This gated pulse is a sine wave masked in the time domain with a certain pulse shape.

A further UWB transmission technique involves orthogonal frequency division multiplexing (OFDM). In OFDM, a single transmitter transmits on several different orthogonal frequencies. OFDM utilizes transformations, such as Fast Fourier Transforms (FFTs) and inverse FFTs (IFFTs) to transfer information at high data rates.

IEEE 802.15.4 is another wireless communications technology. In particular, IEEE 802.15.4 is standard developed by the Institute of Electrical and Electronic Engineers (IEEE). This standard is entitled “Wireless Medium Access Control (MAC) and Physical Layer (PHY) Specifications for Low Rate Wireless Personal Area Networks (LR-WPANs).” IEEE 802.15.4 allows devices (fixed or mobile) to form short-range ad hoc networks over which they can communicate.

Wireless links under IEEE 802.15.4 can operate in three frequency bands. In particular, the standard provides data rates of 20 kb/sec in the 858 MHz band, data rates of 40 kb/sec in the 902-to-928 MHz band, and data rates of 250 kb/sec in the 2.4 GHz band. This standard also allows for the creation of self-configuring, multihop network topologies. A flexible feature of IEEE 802.15.4 is that it allows devices to operate with other wireless devices, such as wireless local area networks (WLANs), WiFi, and Bluetooth.

ZigBee is yet another emerging wireless communications technology. ZigBee provides a set of communication protocols designed to use small, low power digital radios that are based on the IEEE 802.15.4 standard for wireless personal area networks (WPANs). These protocols provide for the creation of low data rate ad-hoc and mesh networks. Such networks ultilize direct sequence spread spectrum (DSSS) transmissions within the ISM band. ZigBee networks are aimed at low power consumption so that devices may operate on batteries for long periods of time. ZigBee networks typically include a single ZigBee coordinator device. Moreover, ZigBee provides for full function devices (FFDs), and reduced function device (RFDs). The software for RFDs requires relatively little storage space.

The Bluetooth Special Interest Group (“Bluetooth SIG”) is a trade association of members from various industries that is driving the development of Bluetooth wireless technology. Currently, the Bluetooth SIG is engaged in discussions regarding devices that can employ both Bluetooth and UWB techniques. In fact, the Bluetooth SIG is further considering adopting UWB communications techniques as a “high rate” Bluetooth.

From a protocol perspective, such considerations involve the employment of UWB-specific physical (PHY) and media access control (MAC) layers. However, certain upper layer protocols would employ Bluetooth host protocol layers (referred to as the BT host stack).

The existing Bluetooth Host Control Interface (HCI) provides an interface between the current BT host stack and the BT radio modules. It is envisioned that the existing HCI could also provide an interface between the BT host stack and UWB MAC and PHY layers without substantial modifications. Hence, a single HCI would provide for both conventional Bluetooth and UWB communications.

However, certain obstacles need to be overcome in developing a single HCI solution. For instance, one obstacle involves the usage of connection handles. A connection handle is an identifier that designates a wireless connection created by a radio module (e.g., by PHY and MAC layers). Upon creation of a wireless connection, the radio module returns a corresponding connection handle to the BT host stack. Currently, there is no negotiation between the host stack and radio regarding the usage of identifiers. Thus, if a host stack is cooperating with multiple radios, conflicts may arise in which different radios employ the same connection handle.

Accordingly, techniques are needed that provide for operation with multiple radios. Further, techniques are needed that prevent conflicts between multiple wireless connections.

### SUMMARY OF THE INVENTION

Embodiments of the present invention provides techniques for devices having multiple radios. For instance, the present invention provides an apparatus having multiple radio modules, a connection identifier resolution module, and a host controller. Each of the radio modules communicates over a wireless connection and assign an internal (i.e., device-internal) connection identifier (e.g., a Bluetooth connection handle) to its corresponding wireless connection. The connection identifier resolution module identifies two or more conflicting connection identifiers assigned by the multiple radio modules. In addition, the connection identifier resolution module assigns one or more alternate connection identifiers. Each of the one or more alternate connection identifiers corresponds to a respective one of the two or more conflicting connection identifiers. The host controller employs the one or more alternate connection identifiers when exchanging information with the plurality of radio modules.

The connection identifier resolution module may include a mapping table that stores correspondences between connection identifiers employed by the plurality of radio modules and connection identifiers employed by the host controller. Further, the apparatus may include an interface that provides for the exchange of information between the host controller and the plurality of radio modules through the connection identifier resolution module.

In embodiments, the radio modules perform physical layer protocol operations and media access control layer protocol layer operations; while the host controller performs operations associated with higher protocol layers.

Various types of radio modules may be employed. Examples of such modules include a Bluetooth radio module, an ultra wideband (UWB) radio module, and/or an IEEE 802.15.4 radio module.

The present invention provides a method that receives, from a radio module, an internal (i.e., device-internal) connection identifier. This connection identifier is assigned by the radio module and corresponds to a wireless connection that is established by the radio module. Also, the method determines whether the received connection identifier is identical to one or more connection identifiers employed by one or more other radio modules. If so, then the following steps are performed: (i) an alternate connection identifier for the received connection identifier is assigned, (ii) the alternate connection identifier is employed when exchanging information regarding the corresponding wireless connection with a host controller, and (iii) the connection identifier assigned by the radio module is employed when exchanging information regarding the corresponding wireless connection with the radio module. The present invention also provides a computer program product that enables a processor to perform such features.

In addition to the above features, the present invention provides an apparatus having multiple radio modules, a host controller, and an interface that provides for the exchange of information between the host controller and the multiple radios. The host controller configured may receive from one of the radio modules, a request to establish a wireless connection, and in response to the request, send a command to the one radio module, wherein the command directs the one radio module to establish a wireless connection having a corresponding connection identifier. The request may include a proposed connection identifier; and the command may include a connection identifier different from the proposed connection identifier when the proposed connection identifier conflicts with a connection identifier employed by another radio module.

A further apparatus of the present invention includes multiple radio modules and a host controller. The radio modules are each configured to communicate over a wireless connection and assign an internal (i.e., device-internal) connection identifier to its corresponding connection. The host controller exchanges information with each of the radio modules using their corresponding connection identifiers. In this apparatus, each radio module assigns the connection identifier to its corresponding connection from a plurality of connection identifiers exclusively reserved for the radio module.

Aspects of the present invention advantageously prevent conflicts between connection identifiers. Further features and advantages of the present invention will become apparent from the following description, and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of a device architecture, according to embodiments of the present invention;

FIG. 2 is a diagram of an exemplary Bluetooth HCI packet;

FIG. 3 is a diagram of a device architecture according to embodiments of the present invention;

FIG. 4 is a flowchart of a resolution module operation, according to embodiments of the present invention;

FIGS. 5 and 6 are diagrams illustrating the exchange of HCI commands provided by aspects of the present invention; and

FIG. 7 is a diagram of an implementation of a wireless communications device, according to embodiments of the present invention.

### DETAILED DESCRIPTION OF THE PREFERRED EMBODIMENTS

I. Multiple Radio Architecture

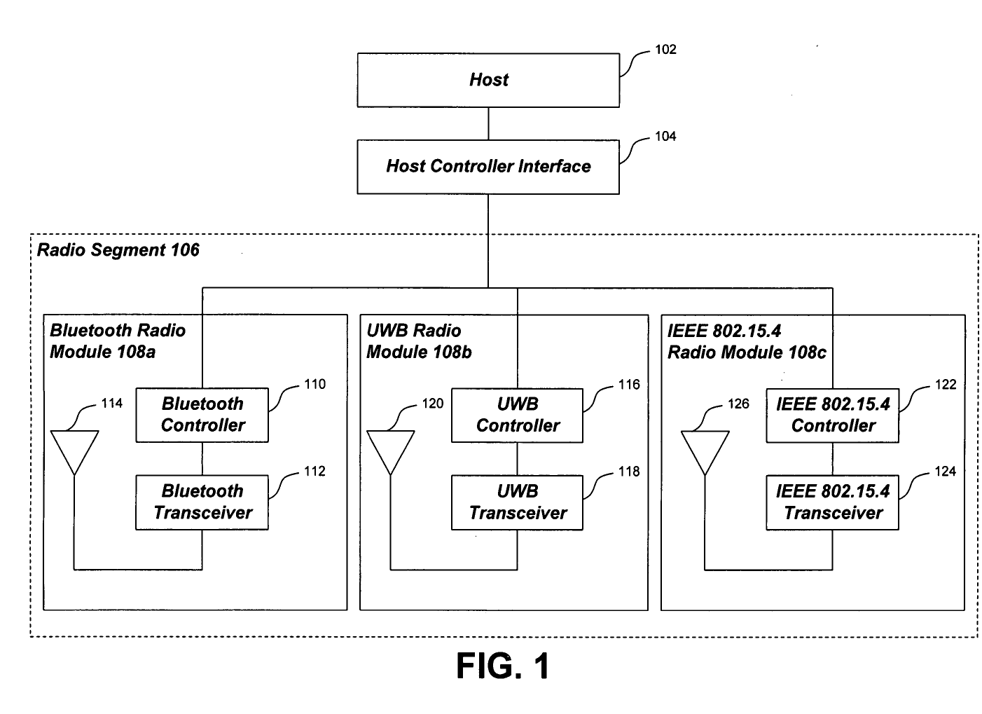

As described above, current considerations involve the employment of UWB-specific PHY and MAC layers in conjunction with a BT host stack. FIG. 1 is a diagram of such an approach. In particular, FIG. 1 shows an architecture for a wireless communications device that may be employed, according to embodiments of the present invention.

The device architecture of FIG. 1 includes a host 102, a host controller interface (HCI) 104, and a radio segment 106. Radio segment 106 may include multiple radio modules (also referred to as radios) 108. For instance, FIG. 1 shows radio segment 106 having a Bluetooth radio module 108a, a UWB radio module 108b, and an IEEE 802.15.4 radio module 108c.

Host 102 is responsible for functions involving user applications and higher protocol layers, while radio segment 106 is responsible for lower layer protocols. For example, Bluetooth radio module 108a is responsible for Bluetooth specific communications with other devices. Similarly, UWB radio module 108b is responsible for UWB specific communications with other UWB capable devices, and IEEE 802.15.4 radio module 108c is responsible for IEEE 802.15.4 specific communications with other IEEE 802.15.4 capable devices.

HCI 104 defines a set of messages, which provide for the exchange of information between host 102 and radio segment 106. Information exchanged in this manner may include commands sent by host 102 and connection data provided by radio segment 106.

FIG. 1 shows that each radio module 108 includes various components. For instance, module 108a includes a Bluetooth controller 110, a Bluetooth transceiver 112, and an antenna 114. Similarly, radio module 108b includes a UWB controller 116, a UWB transceiver 118, and an antenna 120. Also, radio module 108c includes an IEEE 802.15.4 controller 122, an IEEE 802.15.4 transceiver 124, and an IEEE 802.15.4 antenna 126.

Within radio module 108a , Bluetooth controller 110 performs functions related to Bluetooth link set-up, security and control. These functions involve discovering corresponding link managers at remote devices and communicating with them according to a link manager protocol (LMP). To perform these functions, LMP defines a set of messages, which are also referred to as protocol data units (PDUs). Bluetooth controller 110 exchanges these PDUs with link managers at remote devices.

Bluetooth controller 110 exchanges information with host 102 across HCI 104. This information may include commands received from host 102, and information that Bluetooth controller 110 transmits to host 102. As described above, this exchange of information may be according to a defined set of packet formats. Further, Bluetooth controller 110 performs baseband processing for Bluetooth transmissions, such as error correction encoding and decoding. In addition, Bluetooth controller 110 exchanges data between corresponding controllers at remote devices according to a protocol, such as the Bluetooth Link Manager Protocol (LMP).

Bluetooth transceiver 112 is coupled to antenna 114. Transceiver 112 includes electronics that allow the device of FIG. 1 (in conjunction with antenna 114) to exchange wireless Bluetooth signals with remote devices. Such electronics may include, for example, modulators and demodulators, amplifiers, and filters. Moreover, transceiver 112 may be implemented in hardware, software, firmware, or any combination thereof.

As described above, UWB radio module 108b includes a UWB controller 116 and a UWB transceiver 118. UWB controller 116 performs functions related to UWB link set-up, security and control. In addition, UWB controller 116 provides for the exchange of information across UWB links according to one or more protocol layers (e.g., PHY and MAC layers). This may involve performing baseband processing, such as error correction encoding and decoding, as well as buffering. Accordingly, UWB controller 116 exchanges baseband information and control information with UwB transceiver 118.

Moreover, UWB controller 116 exchanges information with host 102 across HCI 104. This information may include commands received from host 102, and information transmitted to host 102. As described above, this exchange of messages may be according to a defined set of packet formats.

UWB transceiver 118 is coupled to antenna 120. UWB transceiver 118 includes electronics, which allow the device of FIG. 1 (in conjunction with antenna 120) to exchange wireless UWB signals with remote devices. For the transmission of UWB signals, such electronics may include a pulse generator. For the reception of UWB signals, such electronics may include timing circuitry and filters. Alternatively, UWB transceiver 118 may include an OFDM modulator, and an OFDM demodulator. Moreover, UWB transceiver 118 may be implemented in hardware, software, firmware, or any combination thereof.

Within IEEE 802.15.4 radio module 108c , IEEE 802.15.4 controller 122 exchanges information (e.g., commands or messages according to a defined set of packet formats) with host 102 across HCI 104. Further, IEEE 802.15.4 controller 122 performs baseband processing for IEEE 802.15.4 transmissions, such as error correction encoding and decoding. In addition, IEEE 802.15.4 controller 122 exchanges data between corresponding controllers at remote devices according to various protocols, such as MAC and PHY protocols.

IEEE 802.15.4 transceiver 124 is coupled to an antenna 126. Transceiver 124 includes electronics that allow the device of FIG. 1 (in conjunction with antenna 126) to exchange wireless Bluetooth signals with remote devices according to the IEEE 802.15.4 PHY protocol. Such electronics may include, for example, modulators and demodulators, amplifiers, and filters. Moreover, transceiver 124 may be implemented in hardware, software, firmware, or any combination thereof.

As described above, controllers 110, 116, and 122 exchange information with host 102 via HCI 104. Such exchanges involve messages or packets pertaining to particular connections of their respective radio segments. In embodiments, these messages or packets include corresponding device-internal (also referred to as internal) connection identifiers. For instance, when Bluetooth protocols (or variations thereof) are employed, these connection identifiers are Bluetooth connection handles. Such connection handles are included in a field of each HCI packet.

II. HCI packets

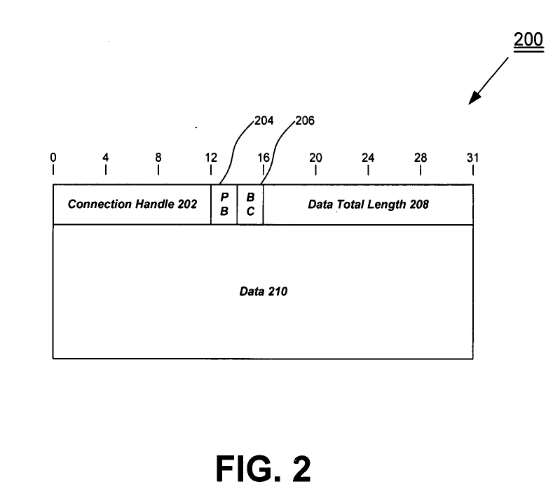

FIG. 2 is a diagram of an exemplary Bluetooth HCI packet 200 that may be exchanged across HCI 104. As discussed above, connection identifiers may be included in each HCI message or packet. Accordingly, FIG. 2 shows that packet 200 includes a 12-bit connection handle field 202. In addition, HCI packet 200 includes a 2-bit packet boundary (PB) flag 204, a 2-bit broadcast (BC) flag 206, a data total length field 208, and a data field 210.

III. Conflict Resolution Module

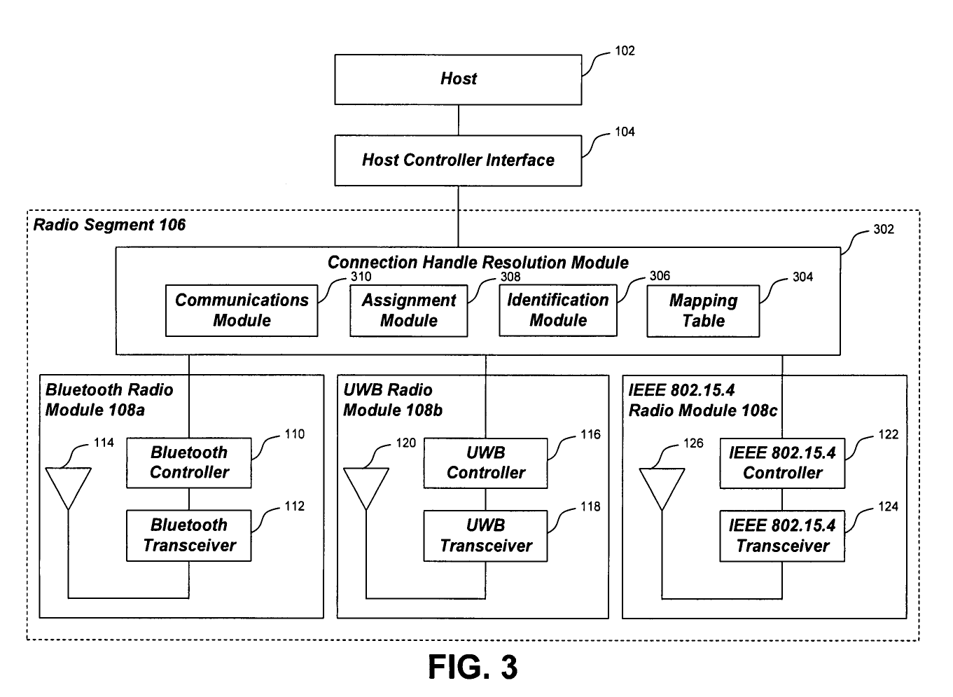

As discussed above, the employment of multiple radio modules creates the possibility of conflicting (e.g., identical) internal connection identifiers being used. In embodiments of the present invention, radio modules may continue to use conflicting connection identifiers, while other entities employ corresponding alternate identifiers. An exemplary device that employs such techniques is described with reference to FIG. 3.

In particular, FIG. 3 is a diagram of a device architecture that is similar to the architecture of FIG. 1. However, in this architecture, radio segment 106 includes a connection handle resolution module 302. This module operates as an intermediary between radio modules 108 and HCI 104.

Conflict resolution module 302 performs conflict identification and packet translation operations. In addition, resolution module 302 maintains a mapping table 304. This table stores correspondences between connection identifiers employed by radio modules 108 and connection identifiers employed by host 102.

Once a connection identifier (e.g., a Bluetooth connection handle) is assigned by a radio module 108, the radio module 108 will start using this identifier in the information (i.e., HCI packets) that it sends to host 102.

Upon first receipt of an assigned connection identifier from a particular radio module 108 (e.g., in an HCI packet), resolution module 302 will store this identifier in mapping table 304 as the identifier currently being used by the radio module 108. In addition, an identification module 306 within resolution module 302 determines from mapping table 304 whether this identifier is currently being used by any other radio modules 108.

If so, then an assignment module 308 within resolution module 302 assigns an alternate connection identifier (e.g., Bluetooth connection handle) for this connection. This alternate identifier will be used in radio-originated information (e.g., HCI packets) corresponding to this connection that is forwarded to host 102 by resolution module 302. In addition, this alternate identifier will be used by host 102 in information that it sends across HCI 104 (e.g., Bluetooth HCI packets) that corresponds to this connection. As shown in FIG. 3, conflict resolution module 302 includes a communications module 310 that handles such communications with radio modules 108 and host 102.

Thus, conflict resolution module 302 performs packet translation operations. This involves replacing connection identifiers in information that is passed across HCI interface 104. Such packet translation operations are described herein with reference to an exemplary mapping table 304, which is shown below in Table 1.

TABLE 1

| | Connection Identifier | Connection Identifier |
|---|---|---|
| Radio Module | Employed by Radio Module | Employed by Host |
| 108a | 0x0001 | 0x0001 |
| 108b | 0x0001 | 0x0002 |
| 108c | 0x0001 | 0x0003 |

Mapping table 304 stores correspondences between the connection identifiers employed by radio modules 108 and host 102. Accordingly, each row in Table 1 corresponds to a particular radio module 108. For each row, Table 1 includes a first entry indicating a connection identifier employed by the corresponding radio module 108. In addition, each row includes a second entry indicating a connection identifier that host 102 uses for the corresponding connection.

Thus, the entries of Table 1 illustrate a manner in which conflicts are resolved, according to aspects of the present invention. More particularly, in Table 1, each of the radio modules employs the same connection identifier (0x0001) for their connections. However, as appointed by resolution module 302, host 102 employs a unique alternate identifier for each of these connections (0x0001 , 0x0002, and 0x0003).

When host 102 sends a message containing an identifier, resolution module 302 looks up this identifier in mapping table 304. From this, resolution module 302 determines the identifier that should be used when forwarding the message to its corresponding radio module 108. This determination may reveal that the received message contains an alternate identifier that needs to be replaced with the identifier (i.e., a conflicting identifier) assigned by the corresponding radio module 108. Alternatively, this determination may reveal that the received message contains the same identifier employed by the corresponding radio module 108. In this case, the identifier does not need to be replaced before the message is sent to the radio module 108.

In addition, conflict module 302 performs time division allocations among radio modules 108. This provides certain time intervals in which HCI communications for each radio module are performed. Through such allocations, radio modules 108 do not utilize host 102 at the same time.

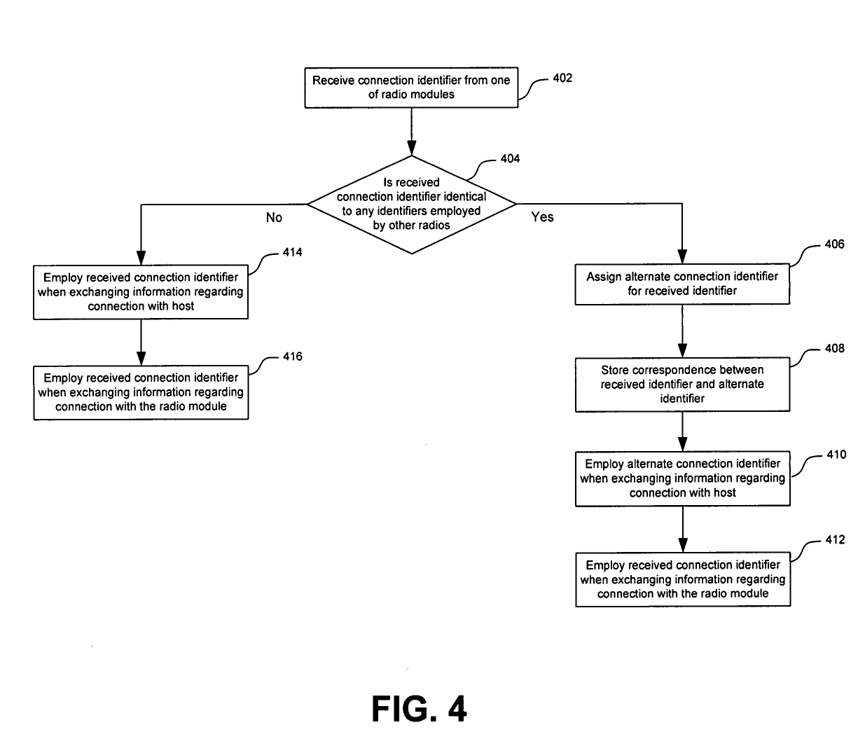

FIG. 4 is a flowchart showing an exemplary operation of resolution module 302, according to embodiments of the present invention. As shown in FIG. 4, this operation includes a step 402 in which resolution module 302 receives a connection identifier from one of radio modules 108. This connection identifier was assigned by the radio module 108 and corresponds to a wireless connection that the radio module 108 established.

Next, in a step 404, resolution module 302 determines whether the connection identifier received in step 402 is identical to any connection identifier(s) employed by other radio module(s). If so, then operation proceeds to a step 406, otherwise operation proceeds to a step 414.

In step 406, resolution module 302 assigns an alternate connection identifier for the received connection identifier. Further, in a step 408, resolution module 302 stores a correspondence between this alternate identifier and the connection identifier received in step 402. This step may comprise storing the correspondence in mapping table 304.

In a step 410, resolution module 302 employs the alternate connection identifier when exchanging information regarding the corresponding wireless connection with host 102. Also, in a step 412, resolution module 302 employs the connection identifier received in step 402 when exchanging information regarding the corresponding wireless connection with the radio module.

As described above, step 414 is performed when it is determined in step 404 that the connection identifier received in step 402 is not identical to any other employed connection identifiers. Accordingly, in step 414, resolution module 302 employs this received connection identifier when exchanging information regarding the corresponding wireless connection with host 102. Likewise, in a step 416, resolution module 302 employs the received connection identifier when exchanging information regarding the corresponding wireless connection with the radio module 108.

Connection handle resolution module 302 may be implemented in hardware, software, firmware, or in any combination thereof. For instance, in embodiments, resolution module 302 is implemented as middleware operating between software of HCI 104 and software of controllers 110, 116, and 122. This middleware and software may be in the form of a computer program product comprising a computer useable medium (e.g., memory, and/or various, optical, and electromagnetic storage media) having computer program logic or program code recorded thereon for enabling a processor in a computer system or device to perform the techniques described herein.

A further approach of the present invention involves the employment of new messages or commands that involve the allocation of connection identifiers (i.e., connection handles). This approach is described with reference to the architectures of FIGS. 1 and 3. However, this approach may further be employed with other architectures.

In this approach, host 102 receives connection establishment requests from radio modules 108. In response, host 102 sends approval commands to the requesting radio modules 108. Such approval commands assign a connection identifier (e.g., a Bluetooth connection handle) to the approved connection. Thus, according to this approach, conflicts between identifiers are avoided, because the identifiers are assigned by a single entity (host 102). Also, if host 102 is starting the connection (i.e., a connection request is not received from the other side), the connection identifier may be allocated by host 102.

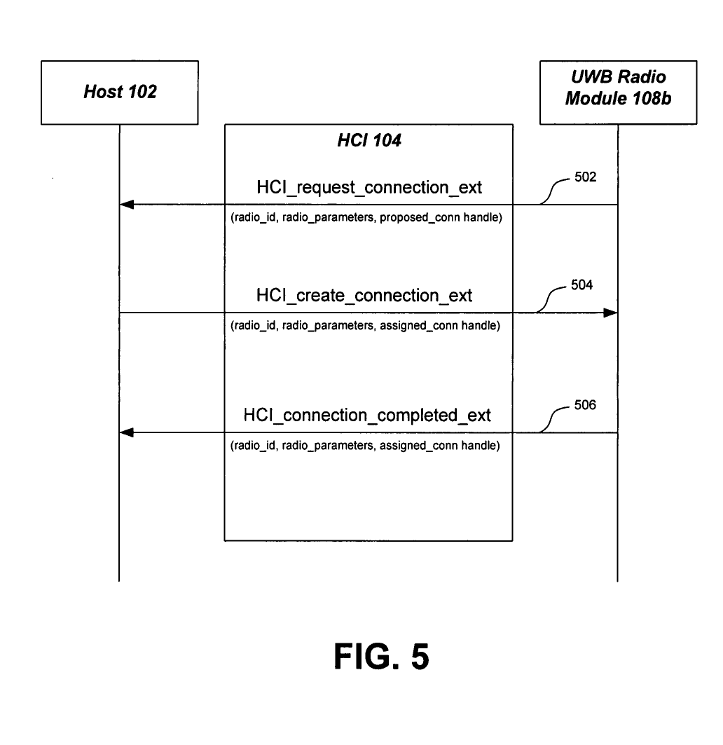

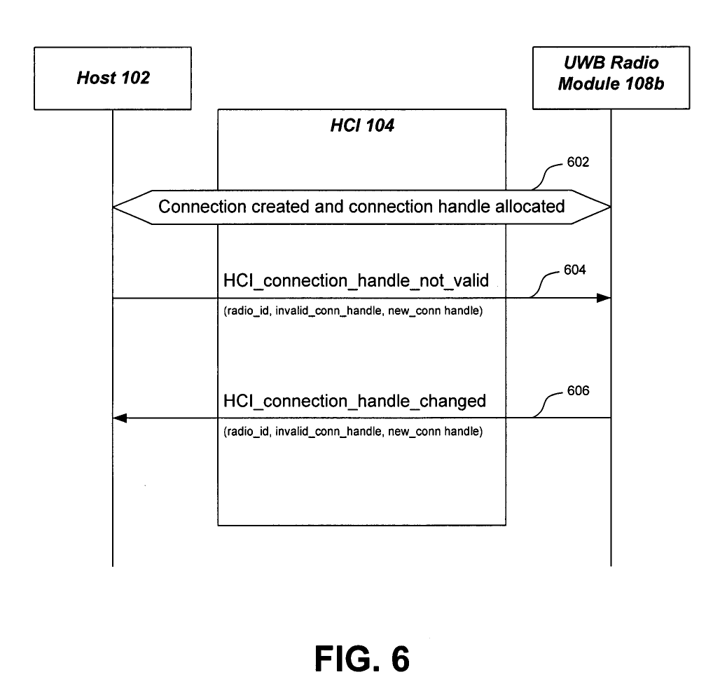

FIGS. 5 and 6 are diagrams illustrating the exchange of HCI commands provided by aspects of the present invention. With reference to FIG. 1, these diagrams illustrate commands exchanged between host 102 and a radio module 108 (e.g., UWB radio module 108b). These commands are exchanged across an interface, such as HCI 104.

Referring to FIG. 5, UWB radio module 108b performs a step 502 in which it has received a connection creation request and sends a create connection request message (shown as HCI_connection_request_ext) to host 102. These connection parameters include a proposed connection identifier (e.g., a Bluetooth connection handle) as well as further parameters. These further parameters may include a radio identifier, and one or more radio parameters (e.g., power, tuning, data rate, etc.).

Upon receipt of this request, host 102 determines whether to approve the requested connection. This determination may be based on various factors. If approved, host 102 further determines whether the proposed connection identifier contained in the request conflicts with any connection identifiers employed by other radio modules (e.g., radio modules 108a and 108c). If the proposed connection identifier so conflicts, then it assigns a different identifier to the requested connection. However, if the proposed connection identifier doesn't conflict with any other identifiers, then it may assign the proposed identifier to the requested connection.

FIG. 5 shows that host 102 performs a step 504. In this step, host 102 generates and sends a create connection command (shown as HCI_create_connection_ext). As shown in FIG. 5, this command includes one or more connection parameters. Although FIG. 5 shows this as a response to a connection request, this command may also be initiated by host 102.

The create connection command sent in step 504 directs UWB radio module 108b to establish a connection according to various parameters conveyed in the message. One of these parameters includes the assigned connection identifier. Upon receipt of this message, UWB radio 108b establishes a connection accordingly. Once this connection is established, UWB radio module 108b sends a connection completed message (shown as HCI_connection_completed_ext) to host 102 in a step 506. As shown in FIG. 5, this message may include the parameters contained in the create connection command of step 504.

The messages of FIG. 5 (HCI_connection_request_ext, HCI_create_connection_ext, and HCI_connection_completed_ext) are not currently provided by the Bluetooth HCI. Accordingly, embodiments of the present invention provide these commands as an extension to Bluetooth.

Yet a further approach of the present invention provides new messages or commands (and events) that indicate and solve possible conflicts. For instance, with reference to FIG. 1, a conflict may happen when a radio module 108 has configured or established a connection and informs host 102 that connection is complete. Once established, the radio module 108 informs host 102 (through HCI 104) of the connection identifier (e.g., Bluetooth connection handle) for the connection. At this point, host 102 is able to determine whether this connection identifier conflicts with any identifiers employed by other radio modules 108.

If host 102 determines that a conflicting connection exists, then embodiments of the present invention provide a command (e.g., an HCI command) for host 102 to inform the radio module 108 that its allocated connection identifier is not usable. Further, this command may also provide the radio module 108 with a new (non-conflicting) connection handle to use.

FIG. 6 is a diagram illustrating an example of this approach. In FIG. 6, UWB radio module 108b creates a connection and allocates a corresponding connection identifier (e.g., Bluetooth connection handle) in a step 602. In addition, this step includes UWB radio module 108b informing host 102 of the allocated connection identifier.

In this example, the allocated connection identifier conflicts with a connection identifier being used by another radio module 108 (e.g., Bluetooth radio module 108a). Therefore, host 102 performs a step 604 in which it sends a command (shown as HCI_connection_handle_not_valid) to UWB radio module 108b. This command indicates that the connection identifier allocated by UWB radio module 108b is not valid. In addition, this command may further provide a new connection identifier for UWB radio module 108b to employ. As shown in FIG. 6, this may command include various parameters such as an identifier of radio module 108b, the invalid connection identifier, and the newly allocated connection identifier.

In response to the command sent in step 604, UWB radio module 108b assigns the new connection identifier to its connection, and informs host 102 of this change by sending it a message (shown as HCI_connection_handle_changed) in a step 606. As shown in FIG. 6, this message may include various parameters, such as an identifier of radio module 108b, the invalid connection identifier, and the newly assigned connection identifier.

In embodiments of the present invention, host 102 will neither accept nor send HCI packets (such as data packets) to or from UWB radio module 108b until it has been notified of the connection identifier change from UWB radio module 108 (i.e., after receipt of the message sent in step 606). After such notification, host 102 will only accept messages from UWB radio 108b that include the new connection identifier.

In further aspects of the present invention, conflicts are avoided by providing each radio module 108 with a reserved exclusive connection identifier space. For example, Bluetooth radio module 108a may be assigned a space from 0x0000 through 0x000F, UWB radio module 108b may be assigned a space from 0x0010 through 0x001F, and IEEE 802.15.4 radio module 108c may assigned a space from 0x0020 through 0x002F.

IV. Wireless Communications Device

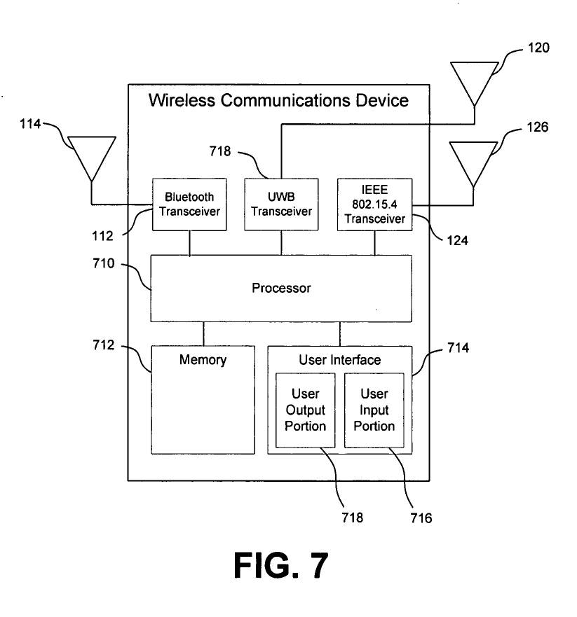

The architectures of FIGS. 1 and 3 may be implemented in hardware, software, firmware, or any combination thereof. One such implementation is shown in FIG. 7. This implementation includes a processor 710, a memory 712, and a user interface 714. In addition, the implementation of FIG. 7 includes Bluetooth transceiver 112, antenna 114, UWB transceiver 118, antenna 120, IEEE 802.15.4 transceiver 124, and antenna 126. Transceivers 112, 118, and 124 may be implemented as described above with reference to FIG. 1.

As shown in FIG. 7, processor 710 is coupled to transceivers 112, 118, and 124. Processor 710 controls device operation. Processor 710 may be implemented with one or more microprocessors that are each capable of executing software instructions stored in memory 712.

Memory 712 includes random access memory (RAM), read only memory (ROM), and/or flash memory, and stores information in the form of data and software components (also referred to herein as modules). These software components include instructions or program code that can be executed by processor 710. Thus, aspects of the device may operate as a computer system. Various types of software components may be stored in memory 712. For instance, memory 712 may store software components that control the operations of transceivers 112, 118, and 124. Also, memory 712 may store software components that provide for the functionality of host 102 as well as controllers 110, 116, and 122.

In addition, memory 712 may store software components that control the exchange of information through user interface 714. As shown in FIG. 7, user interface 714 is also coupled to processor 710. User interface 714 facilitates the exchange of information with a user. FIG. 7 shows that user interface 714 includes a user input portion 716 and a user output portion 718. User input portion 716 may include one or more devices that allow a user to input information. Examples of such devices include keypads, touch screens, and microphones. User output portion 718 allows a user to receive information from the wireless communications device. Thus, user output portion 718 may include various devices, such as a display, and one or more audio speakers. Exemplary displays include liquid crystal displays (LCDs), and video displays.

The elements shown in FIG. 7 may be coupled according to various techniques. One such technique involves coupling processor 710, memory 712, user interface 714, and transceivers 112, 118, and 124 through one or more bus interfaces. In addition, each of these components is coupled to a power source, such as a removable and rechargeable battery pack (not shown).

V. Conclusion

While various embodiments of the present invention have been described above, it should be understood that they have been presented by way of example only, and not in limitation. For instance, although examples have been described involving Bluetooth, UWB, and IEEE 802.15.4 , other wireless communications systems are within the scope of the present invention.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An apparatus, comprising:
a plurality of radio modules, each radio module configured to communicate over a wireless connection and assign an internal connection identifier to its corresponding wireless connection;
a connection identifier resolution module configured to identify two or more conflicting connection identifiers assigned by the plurality of radio modules, the connection identifier resolution module further configured to assign one or more alternate connection identifiers, wherein each of the one or more alternate connection identifiers corresponds to a respective one of the two or more conflicting connection identifiers; and
a host controller configured to employ the one or more alternate connection identifiers when exchanging information with the plurality of radio modules.

2. The apparatus of claim 1, wherein the connection identifier resolution module includes a mapping table, the mapping table configured to store correspondences between connection identifiers employed by the plurality of radio modules and connection identifiers employed by the host controller.

3. The apparatus of claim 1, wherein the assigned connection identifiers and alternate connection identifiers are Bluetooth connection handles.

4. The apparatus of claim 1, further comprising an interface configured to provide for the exchange of information between the host controller and the plurality of radio modules through the connection identifier resolution module.

5. The apparatus of claim 1:
wherein the plurality of radio modules perform physical layer protocol operations and media access control layer protocol layer operations; and wherein the host controller performs operations associated with protocol layers higher than the physical layer and the media access control layer.

6. The apparatus of claim 1, wherein the plurality of radio modules include a Bluetooth radio module and an ultra wideband (UWB) radio module.

7. The apparatus of claim 1, wherein the plurality of radio modules include a Bluetooth radio module and an IEEE 802.15.4 radio module.

8. A method, comprising:
(a) receiving from a radio module an internal connection identifier assigned by the radio module, the connection identifier corresponding to a wireless connection established by the radio module;
(b) determining whether the received connection identifier is identical to one or more connection identifiers employed by one or more other radio modules; and
(c) upon a determination in step (c) that the received connection identifier is identical to the one or more connection identifiers employed by the one or more other radio modules:
(i) assigning an alternate connection identifier for the received connection identifier
(ii) employing the alternate connection identifier when exchanging information regarding the corresponding wireless connection with a host controller, and
(iii) employing the connection identifier assigned by the radio module when exchanging information regarding the corresponding wireless connection with the radio module.

9. The method of claim 8, further comprising:
storing a correspondence between the connection identifier assigned by the radio module and the alternate connection identifier.

10. The method of claim 8:
wherein the radio module performs physical layer protocol operations and media access control layer protocol layer operations; and
wherein the host controller performs operations associated with protocol layers higher than the physical layer and the media access control layer.

11. The method of claim 8, wherein the connection identifier assigned by the radio module and the alternate connection identifier are each Bluetooth connection handles.

12. The method of claim 8, wherein step (c)(ii) comprises employing the alternate connection identifier when exchanging information regarding the corresponding wireless connection with the host controller across a host controller interface.

13. A computer program product comprising a computer useable medium having computer program logic recorded thereon for enabling a processor in a computer system, the computer program logic comprising:
program code for enabling the processor to receive from a radio module an internal connection identifier assigned by the radio module, the connection identifier corresponding to a wireless connection established by the radio module;
program code for enabling the processor to determine whether the received connection identifier is identical to one or more connection identifiers employed by one or more other radio modules;
program code for enabling the processor to, upon a determination that the received connection identifier is identical to the one or more connection identifiers employed by the one or more other radio modules, assign an alternate connection identifier for the received connection identifier;
program code for enabling the processor to, upon a determination that the received connection identifier is identical to the one or more connection identifiers employed by the one or more other radio modules, employ the alternate connection identifier when exchanging information regarding the corresponding wireless connection with a host controller; and
program code for enabling the processor to, upon a determination that the received connection identifier is identical to the one or more connection identifiers employed by the one or more other radio modules, employ the connection identifier assigned by the radio module when exchanging information regarding the corresponding wireless connection with the radio module.

14. An apparatus, comprising:
a plurality of radio modules, each radio module configured to engage in wireless communications;
a host controller;
an interface configured to provide for the exchange of information between the host controller and the plurality of radio modules;
wherein the host controller is configured to:
receive from one of the plurality of radio modules, a request to establish a wireless connection, and
in response to the request, send a command to the one radio module, wherein the command directs the one radio module to establish a wireless connection having a corresponding internal connection identifier.

15. The apparatus of claim 14:
wherein the request includes a proposed internal connection identifier; and
wherein the command includes an internal connection identifier different from the proposed internal connection identifier when the proposed internal connection identifier conflicts with an internal connection identifier employed by another radio module.

16. The apparatus of claim 14, wherein the request and response are exchanged across the interface in formats provided by the interface.

17. The apparatus of claim 14, wherein the internal connection identifier is a Bluetooth connection handle.

18. The apparatus of claim 14, wherein the interface is a Bluetooth Host Controller Interface (HCI).

19. An apparatus, comprising:
a plurality of radio modules, each radio module configured to communicate over a wireless connection and assign an internal connection identifier to its corresponding connection; and
a host controller configured to exchange information with each of the radio modules using its corresponding connection identifiers;
wherein each radio module assigns the connection identifier to its corresponding connection from a plurality of connection identifiers exclusively reserved for the radio module.

20. The apparatus of claim 19:
wherein the radio module performs physical layer protocol operations and media access control layer protocol layer operations; and
wherein the host controller performs operations associated with protocol layers higher than the physical layer and the media access control layer.

21. A connection identifier resolution module, comprising:
an identification module configured to identify two or more conflicting device internal connection identifiers assigned by a plurality of radio modules;
an assignment module configured to assign one or more alternate connection identifiers, wherein each of the one or more alternate connection identifiers corresponds to a respective one of the two or more conflicting connection identifiers;
a mapping table configured to store correspondences between the one or more alternate connection identifiers and the two or more conflicting connection identifiers; and
a communications module configured to employ the one or more alternate connection identifiers when communicating with a host controller, and to employ the two or more conflicting connection identifiers when communicating with the respective radio modules.
